(19) United States
(12) Patent Application Publication
(10) Pub. No.: US 2019/0132846 A1
(43) Pub. Date: May 2, 2019

(54) FREQUENCY BAND PROCESSING METHOD AND APPARATUS

(71) Applicant: Huawei Technologies Co., Ltd., Shenzhen (CN)

(72) Inventor: Chaoliang Yong, Shanghai (CN)

(21) Appl. No.: 16/232,951

(22) Filed: Dec. 26, 2018

Related U.S. Application Data
(63) Continuation of application No. PCT/CN2016/088007, filed on Jun. 30, 2016.

(51) Int. Cl. H04W 72/04

(52) U.S. Cl. CPC H04W 72/0453

(57) ABSTRACT

A frequency band processing method and apparatus are provided. The method includes: obtaining, by a base station, CA capability information of a terminal; determining, by the base station based on the CA capability information, that an access frequency band of the terminal is to be switched from a primary frequency band to a secondary frequency band; and sending, by the base station, a switching instruction to the terminal, where the switching instruction is used to instruct the terminal to switch the access frequency band from the primary frequency band to the secondary frequency band. According to the method, after switching, the terminal can obtain a better frequency band combination and achieve a better CA effect, so that larger bandwidth can be obtained and user experience is improved.

### CROSS-REFERENCE TO RELATED APPLICATIONS

This application is a continuation of International Application No. PCT/CN2016/088007 filed on Jun. 30, 2016, the disclosure of which is hereby incorporated by reference in its entirety.

### TECHNICAL FIELD

The present application relates to wireless communications technologies, and in particular, to a frequency band processing method and apparatus.

### BACKGROUND

With development of mobile communications technologies and broadband wireless access technologies, mobile communications services and broadband wireless access services are closely related to each other. To meet a need for a high-bandwidth trend of mobile communication and to cope with a challenge of mobilization of broadband communication, a carrier aggregation (CA) technology is applied to a mobile communications system.

In the CA technology, larger bandwidth is obtained by aggregating a plurality of contiguous or non-contiguous component carriers (CC), so that a system data transmission rate and a system throughput are improved, and a non-contiguous spectrum problem of an operator is also resolved.

The CA technology allows a terminal with a CA capability to use a plurality of aggregated carriers to transmit data. The plurality of aggregated CCs include a primary component carrier (PCC) and at least one secondary component carrier (SCC). The terminal with the CA capability reports the CA capability of the terminal, so that a network side selects an SCC for the terminal based on the CA capability of the terminal.

However, in a multi-band overlapping scenario, the CA capability of the terminal is usually subject to a limitation, and it is probable that CA or an optimal CA combination cannot be implemented.

### SUMMARY

Embodiments of the present application provide a frequency band processing method and apparatus, so as to achieve a better CA effect.

A first aspect of the embodiments of the present application provides a frequency band processing method, where the method is applied to a communications system with frequency band overlapping; in the communications system, a primary frequency band and a secondary frequency band are configured for a serving cell of a terminal, and the terminal initially accesses a network from the primary frequency band; and the method includes:

obtaining, by a base station, CA capability information of the terminal;

determining, by the base station based on the CA capability information, that an access frequency band of the terminal is to be switched from the primary frequency band to the secondary frequency band; and

sending, by the base station, a switching instruction to the terminal, where the switching instruction is used to instruct the terminal to switch the access frequency band from the primary frequency band to the secondary frequency band.

Optionally, the method further includes:

sending, by the base station, configuration information to the terminal, where the configuration information is used to instruct the terminal to first access the network from the secondary frequency band.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

Optionally, the determining, by the base station based on the CA capability information, that an access frequency band of the terminal is to be switched from the primary frequency band to the secondary frequency band includes:

obtaining, by the base station based on the CA capability information, an aggregable frequency band combination corresponding to the primary frequency band and an aggregable frequency band combination corresponding to the secondary frequency band; and

determining, by the base station based on the aggregable frequency band combination corresponding to the primary frequency band and the aggregable frequency band combination corresponding to the secondary frequency band, that the access frequency band of the terminal is to be switched from the primary frequency band to the secondary frequency band.

The determining, by the base station based on the aggregable frequency band combination corresponding to the primary frequency band and the aggregable frequency band combination corresponding to the secondary frequency band, that the access frequency band of the terminal is to be switched from the primary frequency band to the secondary frequency band may be: when the aggregable frequency band combination corresponding to the secondary frequency band is superior to the aggregable frequency band combination corresponding to the primary frequency band, determining, by the base station, that the access frequency band of the terminal is to be switched from the primary frequency band to the secondary frequency band.

A second aspect of the embodiments of the present application provides a frequency band processing method, where the method is applied to a communications system with frequency band overlapping; in the communications system, a primary frequency band and a secondary frequency band are configured for a serving cell of a terminal, and the terminal initially accesses a network from the primary frequency band; and the method includes:

receiving, by the terminal, a switching instruction sent by a base station, where the switching instruction is used to instruct the terminal to switch an access frequency band from the primary frequency band to the secondary frequency band; and

switching, by the terminal, the access frequency band from the primary frequency band to the secondary frequency band according to the switching instruction.

Optionally, the method further includes:

receiving, by the terminal, configuration information sent by the base station, where the configuration information is used to instruct the terminal to first access the network from the secondary frequency band; and

accessing, by the terminal, the network from the secondary frequency band based on the configuration information when accessing the network next time.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

A third aspect of the embodiments of the present application provides a frequency band processing method, where the method is applied to a communications system with frequency band overlapping; in the communications system, a primary frequency band and a secondary frequency band are configured for a serving cell of a terminal, and the terminal initially accesses a network from the primary frequency band; and the method includes:

generating, by a base station, configuration information, where the configuration information is used to instruct the terminal to first access the network from the secondary frequency band; and

sending, by the base station, the configuration information to the terminal.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

A fourth aspect of the embodiments of the present application provides a frequency band processing method, where the method is applied to a communications system with frequency band overlapping; in the communications system, a primary frequency band and a secondary frequency band are configured for a serving cell of a terminal, and the terminal initially accesses a network from the primary frequency band; and the method includes:

receiving, by the terminal, configuration information sent by a base station, where the configuration information is used to instruct the terminal to first access the network from the secondary frequency band; and

accessing, by the terminal, the network from the secondary frequency band based on the configuration information.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

A fifth aspect of the embodiments of the present application provides a frequency band processing apparatus, where the apparatus includes modules that are configured to perform the foregoing method provided in any one of the first aspect and the implementations of the first aspect.

A sixth aspect of the embodiments of the present application provides a frequency band processing apparatus, where the apparatus includes modules that are configured to perform the foregoing method provided in the second aspect and the implementations of the second aspect.

A seventh aspect of the embodiments of the present application provides a frequency band processing apparatus, where the apparatus includes modules that are configured to perform the foregoing method provided in the third aspect and the implementations of the third aspect.

An eighth aspect of the embodiments of the present application provides a frequency band processing apparatus, where the apparatus includes modules that are configured to perform the foregoing method provided in the fourth aspect and the implementations of the fourth aspect.

A ninth aspect of the embodiments of the present application provides a frequency band processing apparatus, where the apparatus includes a processor and a memory, the memory is configured to store a program, and the processor invokes the program stored in the memory, to perform the method provided in the first aspect of this application.

A tenth aspect of the embodiments of the present application provides a frequency band processing apparatus, where the apparatus includes a processor and a memory, the memory is configured to store a program, and the processor invokes the program stored in the memory, to perform the method provided in the second aspect of this application.

An eleventh aspect of the embodiments of the present application provides a frequency band processing apparatus, where the apparatus includes a processor and a memory, the memory is configured to store a program, and the processor invokes the program stored in the memory, to perform the method provided in the third aspect of this application.

A twelfth aspect of the embodiments of the present application provides a frequency band processing apparatus, where the apparatus includes a processor and a memory, the memory is configured to store a program, and the processor invokes the program stored in the memory, to perform the method provided in the fourth aspect of this application.

A thirteenth aspect of the embodiments of the present application provides a frequency band processing apparatus, including at least one processing element (or chip) configured to perform the foregoing method according to the first aspect.

A fourteenth aspect of the embodiments of the present application provides a frequency band processing apparatus, including at least one processing element (or chip) configured to perform the foregoing method according to the second aspect.

A fifteenth aspect of the embodiments of the present application provides a frequency band processing apparatus, including at least one processing element (or chip) configured to perform the foregoing method according to the third aspect.

A sixteenth aspect of the embodiments of the present application provides a frequency band processing apparatus, including at least one processing element (or chip) configured to perform the foregoing method according to the fourth aspect.

A seventeenth aspect of the embodiments of the present application provides a program, where when executed by a processor, the program is used to perform the foregoing method according to the first aspect.

An eighteenth aspect of the embodiments of the present application provides a program product, such as a computer-readable storage medium, where the program product includes the program according to the seventeenth aspect.

A nineteenth aspect of the embodiments of the present application provides a program, where when executed by a processor, the program is used to perform the foregoing method according to the second aspect.

A twentieth aspect of the embodiments of the present application provides a program product, such as a computer-readable storage medium, where the program product includes the program according to the nineteenth aspect.

A twenty-first aspect of the embodiments of the present application provides a program, where when executed by a processor, the program is used to perform the foregoing method according to the third aspect.

A twenty-second aspect of the embodiments of the present application provides a program product, such as a computer-readable storage medium, where the program product includes the program according to the twenty-first aspect.

A twenty-third aspect of the embodiments of the present application provides a program, where when executed by a processor, the program is used to perform the foregoing method according to the fourth aspect.

A twenty-fourth aspect of the embodiments of the present application provides a program product, such as a computer-readable storage medium, where the program product includes the program according to the twenty-third aspect.

In the foregoing aspects, the base station determines, based on the CA capability information of the terminal, that the access frequency band of the terminal is to be switched from the primary frequency band to the secondary frequency band, and sends the switching instruction to the terminal, so that the terminal switches the access frequency band from the primary frequency band to the secondary frequency band according to the switching instruction. After switching, the terminal can obtain a better frequency band combination and achieve a better CA effect, so that larger bandwidth can be obtained and user experience is improved.

### BRIEF DESCRIPTION OF THE DRAWINGS

To describe the technical solutions in the embodiments of the present application or in the prior art more clearly, the following briefly describes the accompanying drawings required for describing the embodiments or the prior art. Apparently, the accompanying drawings in the following description show some embodiments of the present application, and persons of ordinary skill in the art may derive other drawings from these accompanying drawings without creative efforts.

FIG. 1 is a framework diagram of a communications system;

FIG. 2 is a schematic diagram of a CA scenario;

FIG. 3 is a schematic diagram of intra-band contiguous CA;

FIG. 4 is a schematic diagram of intra-band non-contiguous CA;

FIG. 5 is a schematic diagram of inter-band CA;

FIG. 6 is a schematic diagram of frequency band overlapping;

FIG. 7 is a schematic flowchart of a frequency band processing method according to an embodiment of the present application;

FIG. 8 is a schematic flowchart of another frequency band processing method according to an embodiment of the present application;

FIG. 9 is a schematic structural diagram of a frequency band processing apparatus according to an embodiment of the present application;

FIG. 10 is a schematic structural diagram of another frequency band processing apparatus according to an embodiment of the present application;

FIG. 11 is a schematic structural diagram of another frequency band processing apparatus according to an embodiment of the present application;

FIG. 12 is a schematic structural diagram of another frequency band processing apparatus according to an embodiment of the present application;

FIG. 13 is a schematic structural diagram of a base station according to an embodiment of the present application; and

FIG. 14 is a schematic structural diagram of a terminal according to an embodiment of the present application.

### DETAILED DESCRIPTION

The following describes some terms in the embodiments of the present application for ease of understanding by persons skilled in the art.

A base station, also referred to as a radio access network (RAN) device, is a device that connects a terminal to a wireless network. The base station may be a base transceiver station (BTS) in the Global System for Mobile communications (GSM) or the Code Division Multiple Access (CDMA) system, or may be a NodeB (NB) in the Wideband Code Division Multiple Access (WCDMA) system, or may be an evolved NodeB (eNB or eNodeB) in the Long Term Evolution (LTE) system, a relay node, an access point, a base station in a future 5G network, or the like. This is not limited herein.

A terminal may be a wireless terminal or a wired terminal. The wireless terminal may be a device that provides a user with voice and/or other service data connectivity, a handheld device with a wireless connection function, or another processing device connected to a wireless modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, the wireless terminal may be a device such as a personal communication service (PCS) phone, a cordless telephone set, a Session Initiation Protocol (SIP) phone, a wireless local loop (WLL) station, or a personal digital assistant (PDA). The wireless terminal may also be referred to as a system, a subscriber unit, a subscriber station, a mobile station, a mobile console, a remote station, a remote terminal, an access terminal, a user terminal, a user agent, or a user device (user equipment). This is not limited herein.

In the embodiments of the present application, “a plurality of” means two or more than two. “And/or” describes an association relationship of associated objects and represents that three relationships may exist. For example, A and/or B may represent the following three cases: Only A exists, both A and B exist, and only B exists. The character “/” generally indicates an “or” relationship between the associated objects before and after the character.

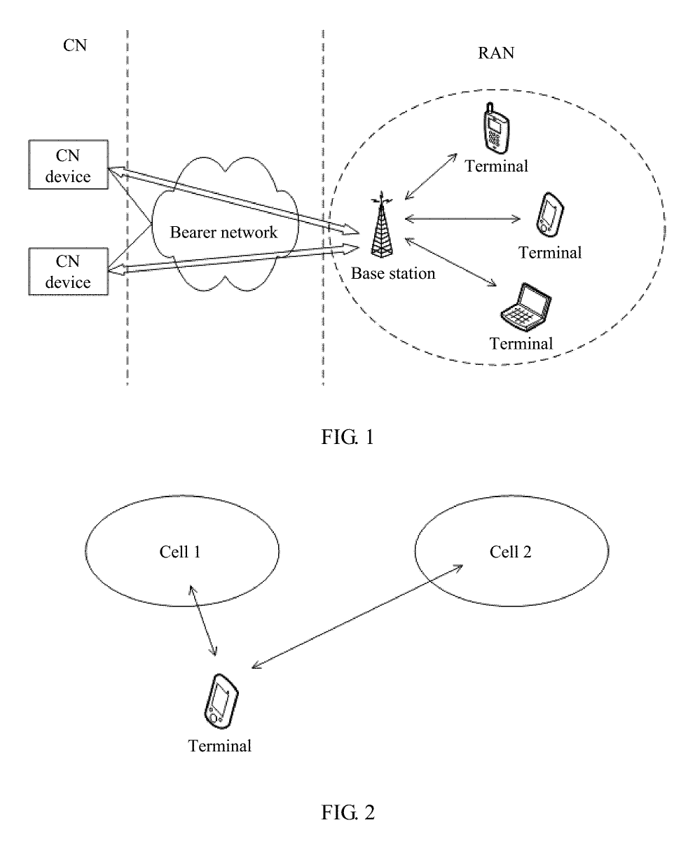

FIG. 1 is a framework diagram of a communications system. As shown in FIG. 1, the communications system includes a core network (CN) and a radio access network (RAN), and the CN may communicate with the RAN through a bearer network (also referred to as a transport network). For example, the bearer network includes devices such as an optical fiber and a router. A terminal accesses the RAN through a base station, and communicates with an external network through a CN device.

FIG. 2 is a schematic diagram of a CA scenario. As shown in FIG. 2, a terminal accesses a wireless network in a cell 1, and the terminal is a terminal that supports CA and may report a CA capability to a base station serving the cell 1. The base station serving the cell 1 may configure a cell 2 as a secondary cell for the terminal based on the CA capability reported by the terminal. The cell 1 and the cell 2 transmit data for the terminal together. The cell 1 is a primary cell and corresponds to a PCC; the cell 2 is a secondary cell and corresponds to an SCC. This is a CA scenario in which two CCs are used as an example for description. Actually, more CCs may be aggregated to serve the terminal. Based on distribution of the aggregated CCs in a frequency band, CA may be classified into intra-band aggregation (Intra-band CA) and inter-band aggregation (Inter-band CA). The intra-band CA is classified into contiguous CA and non-contiguous CA.

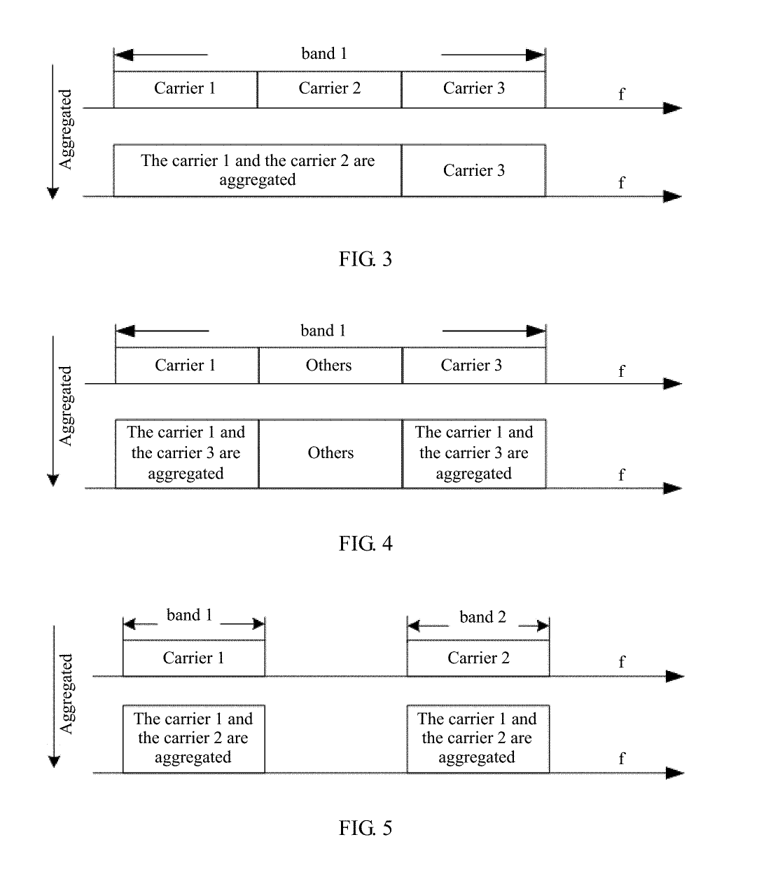

Referring to FIG. 3 to FIG. 5, FIG. 3 is a schematic diagram of intra-band contiguous CA. As shown in FIG. 3, contiguous carriers, a carrier 1 and a carrier 2, in a same frequency band, a band 1, may be aggregated to provide larger transmission bandwidth for a terminal. FIG. 4 is a schematic diagram of intra-band non-contiguous CA. As shown in FIG. 4, non-contiguous carriers, a carrier 1 and a carrier 3, in a same frequency band, a band 1, may be aggregated to provide larger transmission bandwidth for a terminal. FIG. 5 is a schematic diagram of inter-band CA. As shown in FIG. 5, carriers, a carrier 1 and a carrier 2, in different frequency bands, a band 1 and a band 2, may be aggregated to provide larger transmission bandwidth for a terminal. In all the foregoing accompanying drawings, “f” represents frequency.

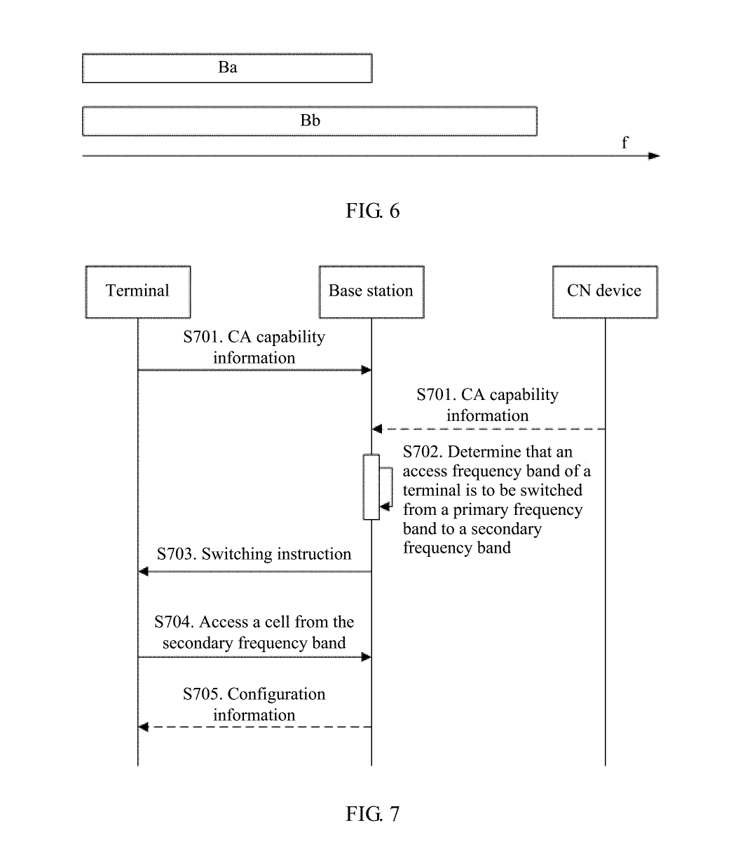

Currently, a frequency band overlapping scenario exists in a network, that is, a same physical frequency is distributed in different frequency bands. This is also referred to as a multi-band overlapping scenario. Referring to FIG. 6, in FIG. 6, a frequency band Ba and a frequency band Bb have an overlapping region in frequency. A plurality of frequency bands may be configured for a cell whose frequency is in this region. For example, the frequency band Ba and the frequency band Bb are configured. One frequency band is a primary frequency band, the other frequency band is the secondary frequency band, and a frequency of the cell in the primary frequency band is different from a frequency of the cell in the secondary frequency band. For example, the frequency band Ba is the primary frequency band, and the frequency band Bb is the secondary frequency band. In FIG. 6, “f” represents frequency.

Currently, a terminal first accesses the network from the primary frequency band. CA capabilities of the terminal in the primary frequency band and the secondary frequency band may be different. For example, there are the following scenarios:

(1) The primary frequency band does not support CA, but the secondary frequency band supports the CA.

(2) The primary frequency band supports 2CC aggregation (2CC), and the secondary frequency band supports 3CC aggregation (3CC).

(3) The primary frequency band does not support uplink (UL) 2CC, but the secondary frequency band supports UL 2CC.

(4) The primary frequency band does not support inter-system aggregation, but the secondary frequency band supports inter-system aggregation. There may be a plurality of cases of inter-system aggregation, for example, aggregation between frequency division duplex (FDD) and time division duplex (TDD). This is not limited herein.

The difference or asymmetry in the CA capabilities of the terminal in the primary frequency band and the secondary frequency band may affect a CA effect. For example, when the primary frequency band Ba does not support the CA but the secondary frequency band Bb supports the CA, if the terminal first accesses the network from the primary frequency band Ba, the CA cannot be performed, and user experience is affected. For another example, when the primary frequency band Ba supports 2CC and the secondary frequency band Bb supports 3CC, if the terminal first accesses the network from the primary frequency band Ba, only 2CC can be performed, and a CA capability is not fully utilized to achieve a desirable effect. For still another example, when the primary frequency band Ba does not support UL 2CC, but the secondary frequency band Bb supports UL 2CC, if the terminal first accesses the network from the primary frequency band Ba, UL 2CC cannot be performed, and a CA capability is not fully utilized to achieve a desirable effect. For yet another example, when the primary frequency band Ba does not support inter-system aggregation but the secondary frequency band Bb supports inter-system aggregation, if the terminal first accesses the network from the primary frequency band Ba, inter-system aggregation cannot be performed, and user experience is affected.

In view of such cases, an embodiment of the present application provides a frequency band processing method, to allow a terminal to access a network from a more suitable frequency band, thereby improving user experience.

The frequency band processing method is mainly applied to a communications system with frequency band overlapping. In the communications system, a primary frequency band and a secondary frequency band are configured for a serving cell of the terminal, and the terminal initially accesses a network from the primary frequency band.

FIG. 7 is a schematic flowchart of a frequency band processing method according to an embodiment of the present application. As shown in FIG. 7, the method includes the following steps.

S701. A base station obtains CA capability information of a terminal.

The base station may obtain the CA capability information of the terminal from the terminal, or may obtain the CA capability information of the terminal from a CN. For example, the terminal may proactively report the CA capability information of the terminal to the base station, or when the base station needs the CA capability information of the terminal, the base station may query the terminal, and the terminal then reports the CA capability information of the terminal to the base station. When the CA capability information is reported by the terminal, the terminal may report the CA capability information of the terminal to the base station by using an information element “supported BandCombination”. When the CA capability information of the terminal is obtained from the CN, the CA capability information of the terminal may be sent by a CN device to the base station by using a context of the terminal.

S702. The base station determines, based on the CA capability information, that an access frequency band of the terminal is to be switched from a primary frequency band to a secondary frequency band.

Based on the CA capability information reported by the terminal, the base station may learn of a CA frequency band combination supported by the terminal. In addition, CA configurations and bandwidth combination sets are stored in the base station. The base station may determine, based on the CA configurations and bandwidth combination sets, a CA frequency band combination that can be supported by the terminal in the primary frequency band and a CA frequency band combination that can be supported by the terminal in the secondary frequency band. The CA frequency band combination that can be supported by the terminal in the primary frequency band is compared with the CA frequency band combination that can be supported by the terminal in the secondary frequency band, to determine which frequency band can achieve a better CA effect. If the primary frequency band can achieve the better CA effect, no switching needs to be performed; if the secondary frequency band can achieve the better CA effect, it is determined that the access frequency band of the terminal is to be switched from the primary frequency band to the secondary frequency band. Using the foregoing scenarios as an example, when larger bandwidth is obtained through frequency band aggregation supported by the secondary frequency band, it is determined that the access frequency band of the terminal is to be switched from the primary frequency band to the secondary frequency band.

S703. The base station sends a switching instruction to the terminal, where the switching instruction is used to instruct the terminal to switch the access frequency band from the primary frequency band to the secondary frequency band.

S704. The terminal receives the switching instruction sent by the base station, and accesses a cell from the secondary frequency band according to the switching instruction.

The foregoing switching from the primary frequency band to the secondary frequency band may be implemented through intra-cell switching, the switching instruction may be a radio resource control (RRC) connection reconfiguration message, and the RRC connection reconfiguration message carries a frequency of the cell in the secondary frequency band, so that the terminal re-accesses the cell in the frequency in the secondary frequency band. Further, the RRC connection reconfiguration message may further carry information about an SCC, so as to notify the terminal of an aggregated SCC.

After the terminal accesses the cell from the secondary frequency band, the base station may perform CA based on an aggregable frequency band combination corresponding to the secondary frequency band, so as to obtain larger bandwidth.

In this embodiment, the base station determines, based on the CA capability information of the terminal, that the access frequency band of the terminal is to be switched from the primary frequency band to the secondary frequency band, and sends the switching instruction to the terminal, so that the terminal switches the access frequency band from the primary frequency band to the secondary frequency band according to the switching instruction. After switching, the terminal can obtain a better frequency band combination and achieve a better CA effect, so that larger bandwidth can be obtained and user experience is improved.

Optionally, before step S702, the base station may first determine a current access frequency band of the terminal. If the current access frequency band is the primary frequency band, steps S702 and S703 are performed; if the current access frequency band of the terminal is the secondary frequency band, steps S702 and S703 do not need to be performed.

Further, the determining, by the base station based on the CA capability information, that an access frequency band of the terminal is to be switched from a primary frequency band to a secondary frequency band may be: obtaining, by the base station based on the CA capability information, an aggregable frequency band combination corresponding to the primary frequency band and an aggregable frequency band combination corresponding to the secondary frequency band; and determining, by the base station based on the aggregable frequency band combination corresponding to the primary frequency band and the aggregable frequency band combination corresponding to the secondary frequency band, that the access frequency band of the terminal is to be switched from the primary frequency band to the secondary frequency band.

The determining, by the base station based on the aggregable frequency band combination corresponding to the primary frequency band and the aggregable frequency band combination corresponding to the secondary frequency band, that the access frequency band of the terminal is to be switched from the primary frequency band to the secondary frequency band may be: when the aggregable frequency band combination corresponding to the secondary frequency band is superior to the aggregable frequency band combination corresponding to the primary frequency band, determining, by the base station, that the access frequency band of the terminal is to be switched from the primary frequency band to the secondary frequency band.

It should be noted that, the aggregable frequency band combination corresponding to the primary frequency band is the CA frequency band combination that can be supported by the terminal in the primary frequency band, and the aggregable frequency band combination corresponding to the secondary frequency band is the CA frequency band combination that can be supported by the terminal in the secondary frequency band. The CA frequency band combination that can be supported by the terminal in the primary frequency band is compared with the CA frequency band combination that can be supported by the terminal in the secondary frequency band. When the CA frequency band combination that can be supported by the terminal in the secondary frequency band can achieve a better CA effect, for example, larger system bandwidth can be obtained, it is determined that the access frequency band of the terminal is to be switched from the primary frequency band to the secondary frequency band.

A frequency band combination that is superior to the aggregable frequency band combination corresponding to the primary frequency band may exist in the aggregable frequency band combination corresponding to the secondary frequency band. Specifically, which frequency band combination is superior may be determined according to a quantity of frequency bands, a quantity of multiple-input multiple-output (MIMO) layers, a quantity of uplink carriers, or the like in the aggregable frequency band combination. For example, a frequency band combination with more frequency bands is superior to a frequency band combination with fewer frequency bands, a frequency band combination with more MIMO layers is superior to a frequency band combination with fewer MIMO layers, a frequency band combination with more uplink carriers is superior to a frequency band combination with fewer uplink carriers, or the like. This is not limited herein.

It should be noted that, for different operators, different terminals, and different application scenarios, the aggregable frequency band combinations corresponding to the primary frequency band and the secondary frequency band are different, and the base station analyzes, based on the CA capability information reported by the terminal, the frequency band combination corresponding to the primary frequency band and the frequency band combination corresponding to the secondary frequency band, to learn of which frequency band combination is superior, so as to determine whether the terminal needs to perform switching. For example:

(a) An operator supports CA to be performed in a primary frequency band and a secondary frequency band, but multi-carrier aggregation capabilities supported by a terminal in the primary frequency band and the secondary frequency band (reference may be made to the foregoing four application scenarios) are different. Assuming that a primary frequency band configured by a base station is denoted as Ba and a secondary frequency band configured by the base station is denoted as Bb, aggregable frequency band combinations supported by the terminal include: Ba+Bc, Bb+Bc, and Bb+Bc+Bd. Bc and Bd are frequency bands other than the primary frequency band and the secondary frequency band.

The base station may learn, based on CA capability information reported by the terminal, that if the terminal accesses a network from the primary frequency band Ba, aggregation of a maximum of only two frequency bands “Ba+Bc” can be performed, but if the terminal accesses the network from the secondary frequency band Bb, aggregation of a maximum of three frequency bands “Bb+Bc+Bd” can be performed, so that larger bandwidth can be provided and user experience are better. After switching, the aggregation of three frequency bands “Bb+Bc+Bd” can be performed.

(b) Uplink and downlink capabilities supported by a terminal in a primary frequency band and a secondary frequency band are inconsistent. For example, assuming that a primary frequency band configured for a cell is denoted as Ba and a secondary frequency band configured for the cell is denoted as Bb, aggregable frequency band combinations supported by the terminal include: Ba+Bc and Bb+Bc, but “Ba+Bc” can only support Ba single uplink aggregation, and “Bb+Bc” supports Bb and Bc dual uplink aggregation. If the terminal accesses a network from the primary frequency band Ba, the dual uplink aggregation cannot be performed.

After switching, the Bb and Bc dual uplink aggregation can be performed.

It should be noted that, if there are a plurality of secondary frequency bands, the base station may alternatively determine, based on an aggregable frequency band combination corresponding to each secondary frequency band, which secondary frequency band the access frequency band of the terminal is to be switched to. Specifically, a secondary frequency band including an optimal aggregable frequency band combination is selected for the terminal to access the network. Similarly, which aggregable frequency band combination is superior may be determined according to a quantity of frequency bands, a quantity of MIMO layers, a quantity of uplink carriers, or the like in the aggregable frequency band combination. For example, a frequency band combination with more frequency bands is superior to a frequency band combination with fewer frequency bands, a frequency band combination with more MIMO layers is superior to a frequency band combination with fewer MIMO layers, a frequency band combination with more uplink carriers is superior to a frequency band combination with fewer uplink carriers, or the like. This is not limited herein.

Optionally, the base station may further send a frequency band combination indication to the terminal. The frequency band combination indication may carry an identifier of at least one frequency band. The base station may perform frequency band aggregation based on the frequency band combination indication. That is, the base station may notify the terminal of a preferred frequency band combination, and the terminal performs frequency band aggregation based on the combination. For example, if the base station indicates “Bb+Bc+Bd” in the frequency band combination indication, the terminal may perform aggregation of three frequency bands “Bb+Bc+Bd”.

It should be noted that the frequency band combination indication and the foregoing switching instruction may be carried in a same message, or may be carried in different messages. This is not limited herein.

Still referring to FIG. 7, optionally, the base station may further send configuration information to the terminal (S705), to instruct the terminal to first access a cell (or a network) from the secondary frequency band. In other words, priorities of the primary frequency band and the secondary frequency band are changed. In this way, when the terminal performs access next time, CA that is consistent with a currently-selected policy can be implemented without performing switching from the primary frequency band to the secondary frequency band. Preferably, the configuration information may be sent when the terminal is released, for example, the configuration information may be sent by using Idle Mode Mobility Control Info (IMMCI).

When UE is released, a high-priority secondary frequency band is configured in an IMMCI information element, so that when accessing the network next time, the UE does not need to perform intra-cell switching, but selects carrier aggregation that is consistent with a currently-selected policy.

Content of the configuration information is not limited herein, provided that the configuration information can be used to instruct the terminal to first access a cell from the secondary frequency band. In an implementation, the configuration information may include information and a priority of a frequency of the cell in the primary frequency band and information and a priority of a frequency of the cell in the secondary frequency band. The priority of the frequency of the cell in the secondary frequency band is higher than the priority of the frequency of the cell in the primary frequency band. The information of the frequency may be a frequency identifier. In addition, the configuration information may further include another frequency, and the another frequency may be a frequency of the cell in another frequency band, or may be a frequency of another cell. This is not limited herein.

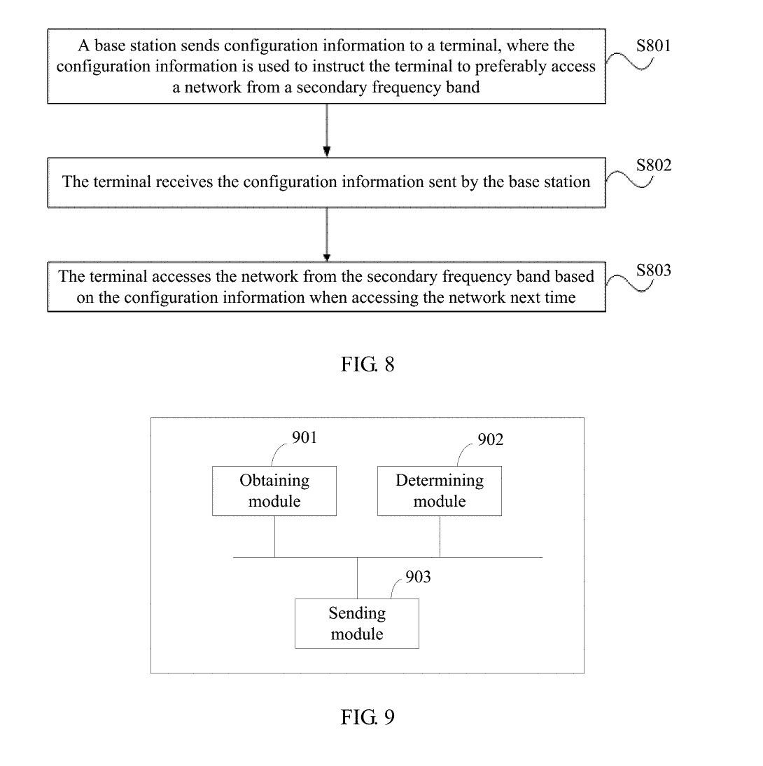

FIG. 8 is a schematic flowchart of another frequency band processing method according to an embodiment of the present application. As shown in FIG. 8, the method includes the following steps.

S801. A base station sends configuration information to a terminal, where the configuration information is used to instruct the terminal to first access a network from a secondary frequency band.

S802. The terminal receives the configuration information sent by the base station.

S803. The terminal accesses the network from the secondary frequency band based on the configuration information when accessing the network next time.

In this manner, the base station notifies the terminal of a preferred frequency band, and the terminal may store the preferred frequency band, so that when accessing the network next time, the terminal directly accesses the network based on the stored optimized frequency band, instead of performing switching after accessing the network.

In specific implementation, when the terminal is in an idle state, the base station may add the configuration information to a release indication message to send to the terminal.

Optionally, when UE is released, a high-priority secondary frequency band is configured in an IMMCI information element, so that when accessing the network next time, the UE does not need to perform intra-cell switching, but selects carrier aggregation that is consistent with a currently-selected policy.

Content of the configuration information is not limited herein, provided that the configuration information can be used to instruct the terminal to first access a cell from the secondary frequency band. In an implementation, the configuration information may include information and a priority of a frequency of the cell in the primary frequency band and information and a priority of a frequency of the cell in the secondary frequency band. The priority of the frequency of the cell in the secondary frequency band is higher than the priority of the frequency of the cell in the primary frequency band. The information of the frequency may be a frequency identifier. In addition, the configuration information may further include another frequency, and the another frequency may be a frequency of the cell in another frequency band, or may be a frequency of another cell. This is not limited herein. After receiving the configuration information, the terminal stores the information and priority of the frequency of the cell in the primary frequency band and the information and priority of the frequency of the cell in the secondary frequency band. When the terminal needs to access the network next time, the terminal determines a highest-priority frequency based on priority information corresponding to each frequency, and accesses the network from the highest-priority frequency.

It should be noted that the embodiment shown in FIG. 8 may alternatively be an independent embodiment. That is, the base station generates the configuration information and sends the configuration information to the terminal.

After receiving the configuration information, the terminal accesses the network from the secondary frequency band based on the configuration information.

After receiving the configuration information, the terminal may store the configuration information. If the terminal has already accessed the network currently, the terminal may access the network from the secondary frequency band when accessing the network next time; if the terminal does not access the network, the terminal may directly access the network from the secondary frequency band when the terminal needs to access the network.

In this embodiment, the base station sends the configuration information to the terminal, to instruct the terminal to first access the network from the secondary frequency band. In this way, the terminal may directly access the network from the secondary frequency band based on the configuration information. An aggregable frequency band combination corresponding to the secondary frequency band is superior to an aggregable frequency band combination corresponding to the primary frequency band; therefore, better frequency band aggregation can be obtained when the terminal accesses the network from the secondary frequency band, thereby improving user experience.

Certainly, the aggregable frequency band combination corresponding to the primary frequency band may be superior. In this case, the base station may not send the configuration information to the terminal, and the terminal accesses the network from the primary frequency band.

FIG. 9 is a schematic structural diagram of a frequency band processing apparatus according to an embodiment of the present application. The apparatus may be located in a base station and is applied to a communications system with frequency band overlapping. In the communications system, a primary frequency band and a secondary frequency band are configured for a serving cell of a terminal, and the terminal initially accesses a network from the primary frequency band. Referring to FIG. 9, the apparatus includes an obtaining module 901, a determining module 902, and a sending module 903.

The obtaining module 901 is configured to obtain CA capability information of the terminal.

The determining module 902 is configured to determine, based on the CA capability information, that an access frequency band of the terminal is to be switched from the primary frequency band to the secondary frequency band.

The sending module 903 is configured to send a switching instruction to the terminal, where the switching instruction is used to instruct the terminal to switch the access frequency band from the primary frequency band to the secondary frequency band.

In this embodiment, the base station determines, based on the CA capability information of the terminal, that the access frequency band of the terminal is to be switched from the primary frequency band to the secondary frequency band, and sends the switching instruction to the terminal, so that the terminal switches the access frequency band from the primary frequency band to the secondary frequency band according to the switching instruction. After switching, the terminal can obtain a better frequency band combination and achieve a better CA effect, so that larger bandwidth can be obtained and user experience is improved.

Further, the sending module 903 is further configured to send configuration information to the terminal, where the configuration information is used to instruct the terminal to first access the network from the secondary frequency band.

The configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

Optionally, the determining module 902 is specifically configured to: obtain, based on the CA capability information, an aggregable frequency band combination corresponding to the primary frequency band and an aggregable frequency band combination corresponding to the secondary frequency band; and determine, based on the aggregable frequency band combination corresponding to the primary frequency band and the aggregable frequency band combination corresponding to the secondary frequency band, that the access frequency band of the terminal is to be switched from the primary frequency band to the secondary frequency band.

The foregoing apparatus may be configured to perform the method provided in the foregoing method embodiment. Specific implementations and technical effects are similar to those of the method provided in the foregoing method embodiment, and details are not described herein again.

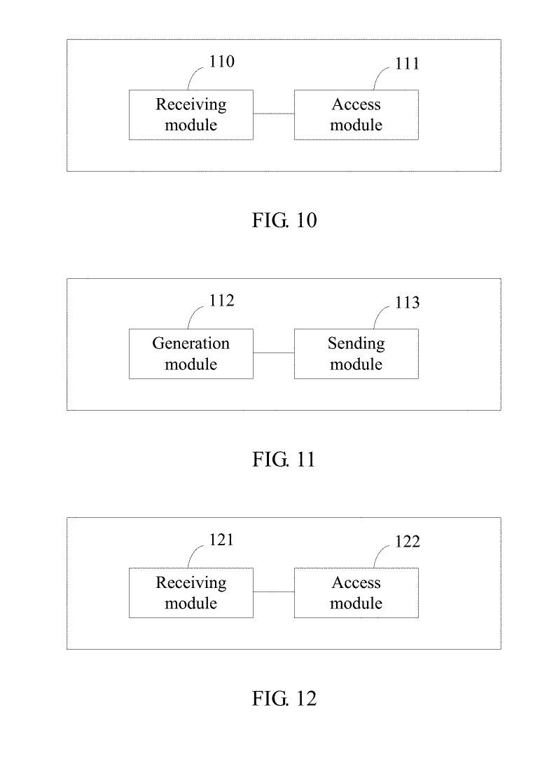

FIG. 10 is a schematic structural diagram of another frequency band processing apparatus according to an embodiment of the present application. The apparatus may be located in a terminal and is applied to a communications system with frequency band overlapping. In the communications system, a primary frequency band and a secondary frequency band are configured for a serving cell of the terminal, and the terminal initially accesses a network from the primary frequency band. Referring to FIG. 10, the apparatus includes a receiving module 110 and an access module 111.

The receiving module 110 is configured to receive a switching instruction sent by a base station, where the switching instruction is used to instruct the terminal to switch an access frequency band from the primary frequency band to the secondary frequency band.

The access module 111 is configured to switch the access frequency band from the primary frequency band to the secondary frequency band according to the switching instruction.

Optionally, the foregoing receiving module 110 is further configured to receive configuration information sent by the base station, where the configuration information is used to instruct the terminal to first access the network from the secondary frequency band.

Correspondingly, the access module 111 accesses the network from the secondary frequency band based on the configuration information when accessing the network next time.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

The foregoing apparatus may be configured to perform the method provided in the foregoing method embodiment. Specific implementations and technical effects are similar to those of the method provided in the foregoing method embodiment, and details are not described herein again.

FIG. 11 is a schematic structural diagram of another frequency band processing apparatus according to an embodiment of the present application. The apparatus may be located in a base station and is applied to a communications system with frequency band overlapping. In the communications system, a primary frequency band and a secondary frequency band are configured for a serving cell of a terminal, and the terminal initially accesses a network from the primary frequency band. As shown in FIG. 11, the apparatus includes a generation module 112 and a sending module 113.

The generation module 112 is configured to generate configuration information, where the configuration information is used to instruct the terminal to first access the network from the secondary frequency band.

The sending module 113 is configured to send the configuration information to the terminal.

In this embodiment, the base station sends the configuration information to the terminal, to instruct the terminal to first access the network from the secondary frequency band. In this way, the terminal may directly access the network from the secondary frequency band based on the configuration information. An aggregable frequency band combination corresponding to the secondary frequency band is superior to an aggregable frequency band combination corresponding to the primary frequency band; therefore, better frequency band aggregation can be obtained when the terminal accesses the network from the secondary frequency band, thereby improving user experience.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

The foregoing apparatus may be configured to perform the method provided in the foregoing method embodiment. Specific implementations and technical effects are similar to those of the method provided in the foregoing method embodiment, and details are not described herein again.

FIG. 12 is a schematic structural diagram of another frequency band processing apparatus according to an embodiment of the present application. The apparatus may be located in a terminal and is applied to a communications system with frequency band overlapping. In the communications system, a primary frequency band and a secondary frequency band are configured for a serving cell of the terminal, and the terminal initially accesses a network from the primary frequency band. As shown in FIG. 12, the apparatus includes a receiving module 121 and an access module 122.

The receiving module 121 is configured to receive configuration information sent by a base station, where the configuration information is used to instruct the terminal to first access the network from the secondary frequency band.

The access module 122 is configured to access the network from the secondary frequency band based on the configuration information.

Optionally, the configuration information includes information and a priority of a frequency of the serving cell in the primary frequency band and information and a priority of a frequency of the serving cell in the secondary frequency band, where the priority of the frequency of the serving cell in the secondary frequency band is higher than the priority of the frequency of the serving cell in the primary frequency band.

The foregoing apparatus may be configured to perform the method provided in the foregoing method embodiment. Specific implementations and technical effects are similar to those of the method provided in the foregoing method embodiment, and details are not described herein again.

It should be noted that the foregoing division of modules of the base station is merely logical function division, and during actual implementation, some or all modules may be integrated into one physical entity, or the modules may be physically separated. In addition, all the modules may be implemented by invoking software by a processing element; or all the modules may be implemented by hardware; or some modules may be implemented by invoking software by a processing element, and some modules may be implemented by hardware. For example, the determining module may be an independently disposed processing element, or may be integrated into a chip of the foregoing apparatus for implementation. In addition, the determining module may alternatively be stored in a memory of the foregoing apparatus in a form of program code, and is invoked by a processing element of the foregoing apparatus, to execute the foregoing functions of the determining module. Implementation of other modules is similar to that of the determining module. In addition, all or some of the modules may be integrated, or may be implemented independently. Herein, the processing element may be an integrated circuit with a signal processing capability. During implementation, the steps of the foregoing methods or the foregoing modules may be implemented by using an integrated logic circuit of hardware in the processor element, or by using a software instruction.

For example, the foregoing modules may be configured as one or more integrated circuits that implement the foregoing methods, such as one or more application-specific integrated circuits (ASIC), one or more microprocessors (digital signal processor, DSP), or one or more field programmable gate arrays (FPGA). For another example, when one of the foregoing modules is implemented by invoking program code by a processing element, the processing element may be a general purpose processor, such as a central processing unit (CPU), or another processor that can invoke program code. For still another example, the modules may be integrated together and implemented in a system-on-a-chip (SOC) form.

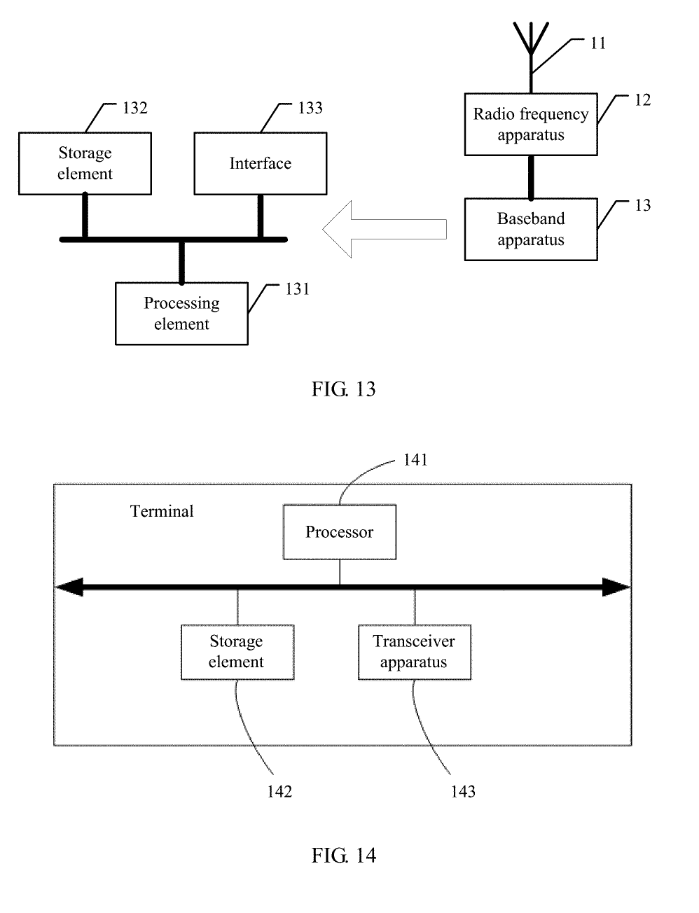

FIG. 13 is a schematic structural diagram of a base station according to an embodiment of the present application. The base station is applied to a communications system with frequency band overlapping. In the communications system, a primary frequency band and a secondary frequency band are configured for a serving cell of a terminal, and the terminal initially accesses a network from the primary frequency band.

Referring to FIG. 13, the apparatus includes an antenna 11, a radio frequency apparatus 12, and a baseband apparatus 13. The antenna 11 is connected to the radio frequency apparatus 12. In an uplink direction, the radio frequency apparatus 12 receives information through the antenna 11, and sends the received information to the baseband apparatus 13 for processing. In a downlink direction, the baseband apparatus 13 processes to-be-sent information, and sends processed information to the radio frequency apparatus 12. After processing the received information, the radio frequency apparatus 12 sends processed information through the antenna 11.

The foregoing frequency band processing apparatus may be located in the baseband apparatus 13, and the method provided in the foregoing embodiments may be implemented in the baseband apparatus 13. The baseband apparatus 13 includes a processing element 131 and a storage element 132. For example, the baseband apparatus 13 may include at least one baseband processing board. A plurality of chips are disposed on the baseband processing board. As shown in FIG. 13, for example, one of the chips is the processing element 131 and is connected to the storage element 132, to invoke a program in the storage element 132, so as to execute an operation shown in the foregoing method embodiments.

The baseband apparatus 13 may further include an interface 133, configured to exchange information with the radio frequency apparatus 12. For example, the interface is a common public radio interface (CPRI).

Herein, the processing element may be one processor, or may be a collective name for a plurality of processing elements. For example, the processing element may be a CPU or an ASIC, or may be configured as one or more integrated circuits that implement the foregoing method, such as one or more microprocessors DSPs, or one or more field programmable gate arrays FPGAs. The storage element may be one memory or may be a collective name for a plurality of storage elements.

FIG. 14 is a schematic structural diagram of a terminal according to an embodiment of the present application. The terminal is applied to a communications system with frequency band overlapping. In the communications system, a primary frequency band and a secondary frequency band are configured for a serving cell of the terminal, and the terminal initially accesses a network from the primary frequency band.

Referring to FIG. 14, the terminal includes a processor 141, a storage element 142, and a transceiver apparatus 143.

The transceiver apparatus 143 may be connected to an antenna. In a downlink direction, the transceiver apparatus 143 receives, through the antenna, information sent by a base station, and sends the information to the processor 141 for processing. In an uplink direction, the processor 141 processes data of the terminal, and sends processed data to the base station through the transceiver apparatus 143.

The storage element 142 is configured to store program code that implements the foregoing method embodiments or the modules in the embodiments shown in FIG. 10 and FIG. 12. The processor 141 invokes the program code, to execute an operation of the foregoing method embodiments, so as to implement the modules in the embodiments shown in FIG. 10 and FIG. 12.

Alternatively, some or all of the foregoing units may be implemented in a form of a field programmable gate array (FPGA) built in a chip of the terminal. The units may be implemented alone, or may be integrated together.

The processing element herein is similar to that described above, and may be a general purpose processor, such as a CPU, or may be configured as one or more integrated circuits that implement the foregoing methods, such as one or more application-specific integrated circuits (ASIC), one or more microprocessors (digital signal processor, DSP), or one or more field programmable gate arrays (FPGA). The storage element may be one storage apparatus or may be a collective name for a plurality of storage elements.

In addition, a plurality of interfaces may be provided on the processor, and are configured to be connected to a peripheral device or an interface circuit that is connected to a peripheral device. For example, the interfaces are configured to be connected to an interface of a display, an interface of a camera, an interface of an audio processing element, and the like.

Finally, it should be noted that the foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present application.

What is claimed is:

1. A frequency band processing method applied to a communications system with frequency band overlapping, wherein in the communications system, a primary frequency band and a secondary frequency band are configured for a serving cell of a terminal, and the terminal initially accesses a network from the primary frequency band, the method comprising:
obtaining, by a base station, carrier aggregation (CA) capability information of the terminal;
determining, by the base station based on the CA capability information, that an access frequency band of the terminal is to be switched from the primary frequency band to the secondary frequency band; and
sending, by the base station, a switching instruction to the terminal for instructing the terminal to switch the access frequency band from the primary frequency band to the secondary frequency band.

2. The method according to claim 1, further comprising:
sending, by the base station, configuration information to the terminal for instructing the terminal to first access the network from the secondary frequency band.

3. The method according to claim 2, wherein the configuration information comprises:
information and a priority of a frequency of the serving cell in the primary frequency band;
information and a priority of a frequency of the serving cell in the secondary frequency band; and
wherein the priority of the frequency of the serving cell in the secondary frequency band is higher than the priority of the frequency of the serving cell in the primary frequency band.

4. The method according to claim 1, wherein determining, by the base station based on the CA capability information, that an access frequency band of the terminal is to be switched from the primary frequency band to the secondary frequency band comprises:
obtaining, by the base station based on the CA capability information, an aggregable frequency band combination corresponding to the primary frequency band and an aggregable frequency band combination corresponding to the secondary frequency band; and
determining, by the base station based on the aggregable frequency band combination corresponding to the primary frequency band and the aggregable frequency band combination corresponding to the secondary frequency band, that the access frequency band of the terminal is to be switched from the primary frequency band to the secondary frequency band.

5. A frequency band processing method applied to a communications system with frequency band overlapping, wherein in the communications system, a primary frequency band and a secondary frequency band are configured for a serving cell of a terminal, and the terminal initially accesses a network from the primary frequency band, the method comprising:
receiving, by the terminal, a switching instruction from a base station, wherein the switching instruction is used to instruct the terminal to switch the access frequency band from the primary frequency band to the secondary frequency band;
accessing, by the terminal, the network from the secondary frequency band according to the switching instruction.

6. The method according to claim 5, further comprising:
receiving, by the terminal, configuration information from the base station, wherein the configuration information is used to instruct the terminal to first access the network from the secondary frequency band; and
accessing, by the terminal, the network from the secondary frequency band based on the configuration information next time.

7. The method according to claim 6, wherein the configuration information comprises information and a priority of a frequency of the serving cell in the primary frequency band and information and a priority of a frequency of the serving cell in the secondary frequency band, wherein the priority of the frequency of the serving cell in the secondary frequency band is higher than the priority of the frequency of the serving cell in the primary frequency band.

8. A frequency band processing apparatus applied to a communications system with frequency band overlapping, wherein in the communications system, a primary frequency band and a secondary frequency band are configured for a serving cell of a terminal, and the terminal initially accesses a network from the primary frequency band, the apparatus comprising:
a processor; and
a non-transitory computer readable storage medium, wherein the non-transitory computer readable storage medium stores a program that, when executed by the processor, causes the apparatus to:
obtain carrier aggregation (CA) capability information of the terminal,
determine, based on the CA capability information, that an access frequency band of the terminal is to be switched from the primary frequency band to the secondary frequency band, and
send a switching instruction to the terminal for instructing the terminal to switch the access frequency band from the primary frequency band to the secondary frequency band.

9. The apparatus according to claim 8, wherein the program, when executed by the processor, causes the apparatus to:
send configuration information to the terminal for instructing the terminal to first access the network from the secondary frequency band.

10. The apparatus according to claim 9, wherein the configuration information comprises:
information and a priority of a frequency of the serving cell in the primary frequency band;
information and a priority of a frequency of the serving cell in the secondary frequency band; and
wherein the priority of the frequency of the serving cell in the secondary frequency band is higher than the priority of the frequency of the serving cell in the primary frequency band.

11. The apparatus according to claim 8, wherein to determine that the access frequency band of the terminal is to be switched from the primary frequency band to the secondary frequency band, the program, when executed by the processor, causes the apparatus to:
obtain, based on the CA capability information, an aggregable frequency band combination corresponding to the primary frequency band and an aggregable frequency band combination corresponding to the secondary frequency band; and determine, based on the aggregable frequency band combination corresponding to the primary frequency band and the aggregable frequency band combination corresponding to the secondary frequency band, that the access frequency band of the terminal is to be switched from the primary frequency band to the secondary frequency band.

12. A frequency band processing apparatus applied to a communications system with frequency band overlapping, wherein in the communications system, a primary frequency band and a secondary frequency band are configured for a serving cell of a terminal, and the terminal initially accesses a network from the primary frequency band, the apparatus comprising:
a processor; and
a non-transitory computer readable storage medium, wherein the non-transitory computer readable storage medium stores a program that, when executed by the processor, causes the apparatus to:
receive a switching instruction from a base station, wherein the switching instruction is used to instruct the terminal to switch the access frequency band from the primary frequency band to the secondary frequency band, and
access the network from the secondary frequency band according to the switching instruction.

13. The apparatus according to claim 12, wherein the program, when executed by the processor, causes the apparatus to:
receive configuration information from the base station, wherein the configuration information is used to instruct the terminal to first access the network from the secondary frequency band; and
accessing the network from the secondary frequency band based on the configuration information next time.

14. The apparatus according to claim 13, wherein the configuration information comprises:
information and a priority of a frequency of the serving cell in the primary frequency band;
information and a priority of a frequency of the serving cell in the secondary frequency band; and
wherein the priority of the frequency of the serving cell in the secondary frequency band is higher than the priority of the frequency of the serving cell in the primary frequency band.
